(19) United States
(12) Patent Application Publication
(10) Pub. No.: US 2025/0375019 A1
(43) Pub. Date: Dec. 11, 2025

(54) MOBILE HAIR STATION

(71) Applicant: Canzatie Flournoy, Los Angeles, CA (US)

(72) Inventor: Canzatie Flournoy, Los Angeles, CA (US)

(21) Appl. No.: 19/201,843

(22) Filed: May 7, 2025

Related U.S. Application Data
(63) Continuation of application No. 16/420,272, filed on May 23, 2019, now abandoned.
(60) Provisional application No. 62/709,735, filed on May 29, 2018.

(51) Int. Cl. A45D 44/04; F16M 11/24

(52) U.S. Cl. CPC A45D 44/04; F16M 11/245

(57) ABSTRACT

A portable hair station. The station includes a base supporting a base stem housing. A primary stem housing is telescopically coupled to the base stem housing, where the primary stem housing comprises a first plurality of hooks that automatically extend from the primary stem housing as the primary stem housing engages the base stem housing and retract into the primary stem housing as the primary stem housing is disengaged from the base stem housing. A secondary stem housing is telescopically coupled to the primary stem housing, where the secondary stem housing comprises a second plurality of hooks that automatically extend from the secondary stem housing as the secondary stem housing engages the primary stem housing and retract into the secondary stem housing as the secondary stem housing is disengaged from the primary stem housing.

### CROSS REFERENCE TO RELATED APPLICATION

This application is a continuation-in-part of U.S. patent application Ser. No. 16/420,272, filed May 23, 2019, the disclosure of which is hereby incorporated by reference in its entirety for all purposes.

### TECHNICAL FIELD

The present disclosure generally relates to cosmetology, and more specifically, to an apparatus for organizing and accessing natural and synthetic hair during styling, braiding and weaving.

### BACKGROUND

When a hairstylist adds natural or synthetic hair to style, braid, or weave into existing hair, the added hair must often be hung or spread over surfaces, chairs, or counters to be accessible to the hairstylist when needed to be woven into the hair. Hairstylists often have to stand for hours while styling a client's hair. When the hairstylist has to reach for hair that's not easily accessible, it often causes the hairstylist to experience back problems or other bodily discomfort, thus making it tiresome and burdensome to manage the added hair.

Hair growing from one's head naturally has the cuticles all going in the same direction; however, the strands of the added artificial or natural hair used for weaves and braids do not. This causes catching and tangling of the added hair the hairstylist is handling.

In sum, a hairstylist's accessibility to the added hair during the styling process can be challenging. For example, when a hairstylist is using the added hair, the hair has to be in close proximity to their client to insure continuous flow and uninterrupted styling of the client's hair. Also, because of the time it takes to style a client's hair, which can be between 3 and 8 hours depending on the style, the lack of proximity and accessibility can increase the time it takes to style the hair. And, finally, the nature of hair used for extensions, weaves and braids lends itself to excessive tangling.

A need, therefore, exists for an apparatus that addresses the aforementioned flow, speed and tangling issues related to natural and synthetic hair. With the use of the present disclosure, users will be able to reduce the time it takes to style a client's hair and reduce the space needed to store and manage the hair.

### SUMMARY

A portable hair station is presently disclosed. The station may include a base supporting a base stem housing. A primary stem housing may be telescopically coupled to the base stem housing, where the primary stem housing comprises a first plurality of hooks that automatically extend from the primary stem housing when the primary stem housing engages the base stem housing and retract into the primary stem housing when the primary stem housing is disengaged from the base stem housing. A secondary stem housing may be telescopically coupled to the primary stem housing, where the secondary stem housing comprises a second plurality of hooks that automatically extend from the secondary stem housing when the secondary stem housing engages the primary stem housing and retract into the secondary stem housing when the secondary stem housing is disengaged from the primary stem housing.

In other implementations, the first plurality of hooks automatically extend from the primary stem housing when a first button coupled to the primary stem housing is engaged and automatically retract into the primary stem housing when the first button is disengaged.

In further implementations, the second plurality of hooks automatically extend from the secondary stem housing when a second button coupled to the secondary stem housing is engaged and automatically retract into the secondary stem housing when the second button is disengaged.

The disclosure of the invention in this summary is not an extensive overview of all contemplated embodiments, it should be appreciated that many other features, applications, embodiments, and/or variations of the disclosed technology will be apparent from the accompanying drawings and the following detailed description, while multiple embodiments are disclosed, however, the drawings and detailed description are to be regarded as illustrative in nature and not restrictive.

### BRIEF DESCRIPTION OF THE DRAWINGS

This disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates an example of a portable hair station according to the teachings of the present disclosure.

FIG. 2 illustrates an alternate implementation of the retractable hanger hooks of the portable hair station of FIG. 1.

FIG. 3A illustrates a perspective view of the portable hair station of FIG. 1 in a stored configuration.

FIG. 3B illustrates an exploded view of the portable hair station of FIG. 1 in the stored configuration.

### DETAILED DESCRIPTION

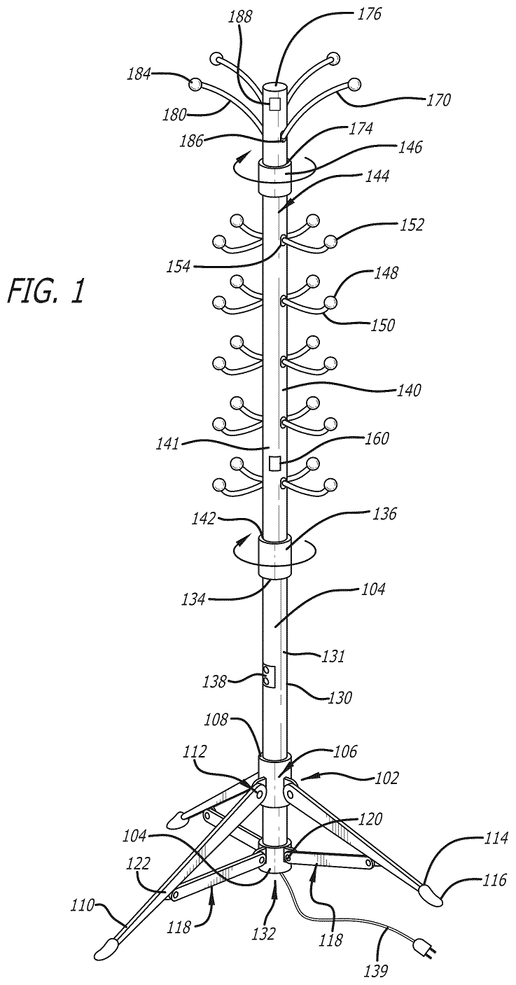

FIGS. 1-3B illustrate examples of various implementations of a portable hair station according to the teachings of the present disclosure. The station may include a base supporting a base stem having a housing. A primary stem may be telescopically coupled to the base stem, where the primary stem housing comprises a first plurality of hooks that automatically extend from the primary stem housing when the primary stem housing engages the base stem housing and retract into the primary stem housing when the primary stem housing is disengaged from the base stem housing. A secondary stem having a housing may be telescopically coupled to the primary stem, where the secondary stem housing comprises a second plurality of hooks that automatically extend from the secondary stem housing when the secondary stem housing engages the primary stem housing and retract into the secondary stem housing when the secondary stem housing is disengaged from the primary stem housing.

In describing the disclosure, it will be understood that a number of implementations, techniques, uses and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

FIG. 1 is a perspective view of hair station 100. As shown, the hair station 100 may include a base 102, a base stem 130, a primary stem 140, and a secondary stem 170. The various components of the base 102, base stem 120, primary stem 140, and secondary stem 170 may each be made of the same or different complimentary materials such as plastic, stainless steel, carbon, aluminum, ceramic, polyvinyl chloride (PVC), or any other suitable material.

The base 102 may comprise a tripod construction having a lower collar 104 adapted to be secured to a lower end of the base stem housing 130, and an upper collar 106 defining a sleeve 108 for passing a portion of the base stem housing 120 therethrough.

The base 102 may include a plurality of collapsible support members 110 each having a first end 112 rotatably coupled to the upper collar 106, and an opposite end 114 configured to rest against a support surface (e.g., a floor). In some implementations, the rubber tips 116 may be applied to the opposite ends 114 to enhance the opposite end's 114 grip with the support surface to provide stability.

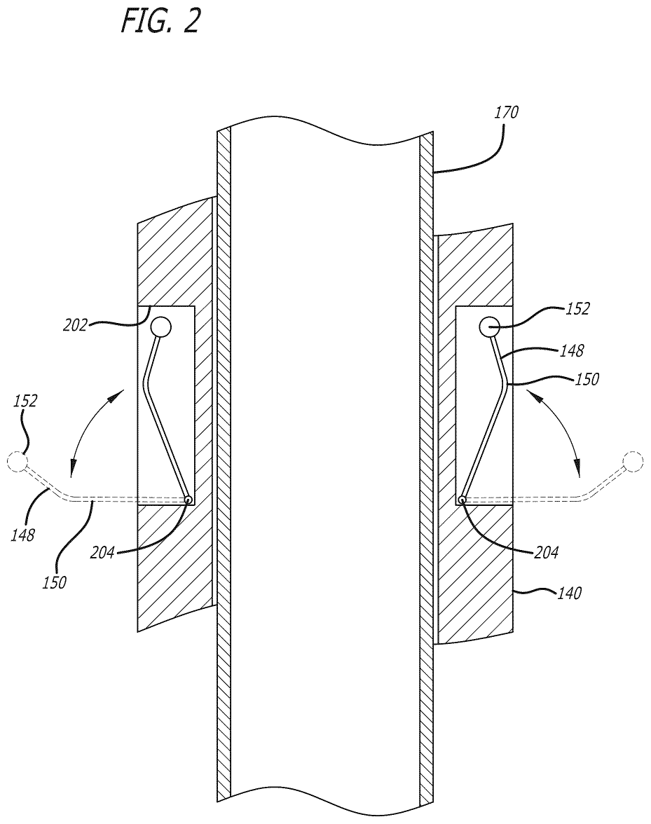

The base 102 may further include a plurality of transverse support members 118 each having a first end 120 rotatably coupled to the lower collar 104, and a second end 122 rotatably coupled to a portion of a corresponding collapsible support member 110. The collapsible support members 110 and the transverse support members 118 are configured to enable the support members to collapse about the base stem 130 during storage, as shown in FIG. 2A, and retracted to the position shown in FIG. 1 when in use.

The base stem housing 130 may comprise an annular housing 131 having a hollowed interior (not shown), a closed end 132 and an open end 134. As mentioned above, the lower collar 104 of the base 102 may be secured to the closed end 132 by fasteners, welding, bonding, interference fit, or other suitable means. The open end 134 is configured to receive a bottom end of the primary stem 140, as will be discussed in more detail below.

A fastener collar 136 may be rotatably coupled to the open end 134 to secure the primary stem 140 to the base stem 130 at a desired height. In this way, the fastener collar 136 may be rotated clockwise to fasten the primary stem 140 to the base stem 130, and counterclockwise to unfasten the primary stem 140 from the base stem 130.

In some implementations, the base stem 130 may include one or more electrical sockets 138 formed into the base stem housing 131 to provide power for various haircare accessories, such as curling irons, blow dryers, and glue guns. In some implementations, the base stem 130 may include an electrical plug 139 at the closed end 132 to supply electrical power to the electrical sockets 138.

Moving upward, the primary stem 140 may comprise an annular housing 141 having a hollowed interior (not shown), a first end 142 and an opposing second end 144. The primary stem housing 141 is constructed such that its outer annular diameter corresponds to the inner annual diameter of the base stem housing 131, thus permitting the first end 142 of the primary stem 140 to be received by and slidably coupled to the open end 134 of the base stem 130 in a telescoping fashion.

A fastener collar 146 may be rotatably coupled to the second end 144 of the primary stem 140 to secure the secondary stem 170 to the primary stem 140 at a desired height. In this way, the fastener collar 146 may be rotated clockwise to fasten the secondary stem 170 to the primary stem 140, and counterclockwise to unfasten the secondary stem 170 from the primary stem 140. Accordingly, the fastener collars 136 and 148 enable the user to adjust the overall height of the hair station 100 to various heights. In some implementations, the total height of the hair station 100 may be adjusted from, for example, 24 inches to 60 inches tall.

The primary stem 140 may comprise a plurality of retractable hanger hooks 148. Each hook 148 may comprise a finger member 150 and a ball tip 152.

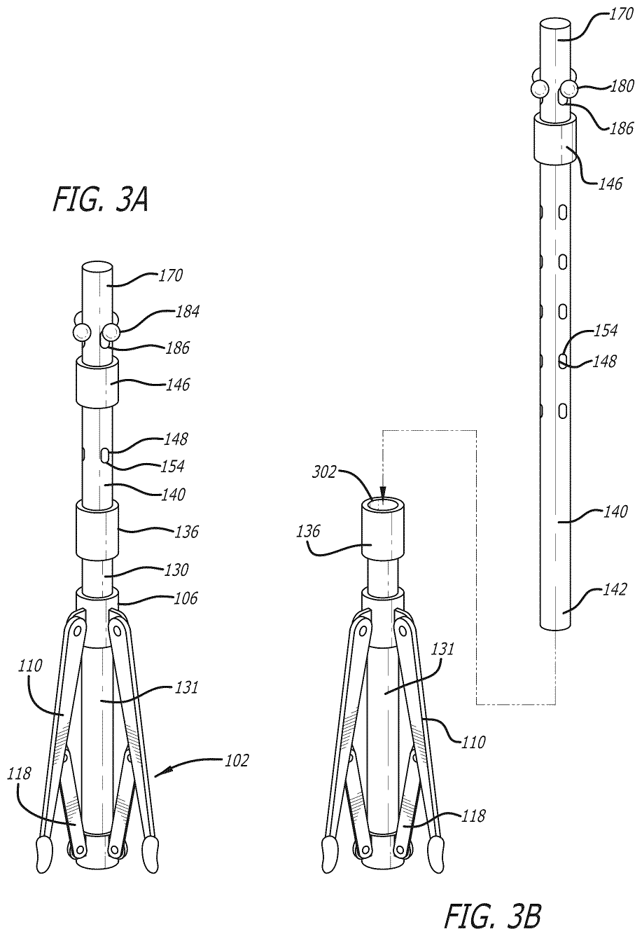

The finger member 150 comprises a slender rod configured to slide in and out of a corresponding orifice 154 formed in the primary stem housing 141. The primary stem housing 141 may include a push button 156, such that when the push button 156 is engaged, the finger members 150 may be automatically extended from a retracted or stored position, as shown in FIGS. 3A and 3B, to an extended position as shown in FIG. 1. Conversely, when the push button 156 is disengaged, the finger members 150 may automatically be retracted from the extended position to the stored position, The components of the push button and linkages coupled thereto used to extend and retract the finger members are various and known in the art and are thus not described herein for simplicity.

In preferred uses of the hair station 100, hair pieces or other hair care accessories may be hung from the retractable hooks 148 as a stylist is styling a client's hair. Thus, the ball tips 152 preferably comprise a rounded finish to prevent hair pieces hanging on the hooks 148 from being snagged as they are removed from the hooks 148. The ball tips 152 may also be constructed from stainless steel, plastic, PVC, ceramic, or other suitable material.

FIG. 2 illustrates an alternative implementation of the retractable hanger hooks 148. In this implementation, a plurality of pockets 202 may be formed in and along the primary stem housing 141 to house the retractable hooks 148. The finger member 150 may include a base end 204 rotatably coupled to a stud 206 formed in the pockets 202 such that the of the finger members 150 may be rotated from a stored position (shown in solid lines) to an extended position (illustrated in dashed lines). In the stored position, the hook 148 may fully rest within the pocket 202. In some implementations, the hooks 148 may be manually rotated between their stored and retracted positions. In other implementations, the hooks 148 may be automatically rotated between their stored and retracted positions when push button 156 is engaged or disengaged.

In other implementations, the retractable hooks 148 may automatically adjust from their stored position to their extended position when the first end 142 of the primary stem 140 is inserted into the open end 134 of the base stem 130. Conversely, the retractable hooks 148 may automatically retract from their extended position back to their stored position when the first end 142 of the primary stem 140 is disengaged from the open end 134 of the base stem 130.

In some implementations, the primary stem 130 may include one or more electrical sockets 160 formed into the primary stem housing 141 to provide power for various haircare accessories, such as curling irons, blow dryers, and glue guns.

Moving again upward, the secondary stem 170 may comprise an annular housing 172 having a hollowed interior (not shown), a bottom end 174 and an opposing closed top end 146. The secondary stem housing 172 is constructed such that its outer annular diameter corresponds to the inner annual diameter of the primary stem housing 141, thus permitting the bottom end 174 of the secondary stem 170 to be received by and slidably coupled to the second end 144 of the primary stem 140 in a telescoping fashion.

The secondary stem 170 may comprise a plurality of retractable hanger hooks 180. Each hook 180 may comprise a finger member 182 and a ball tip 184.

The finger member 182 comprises a slender rod configured to slide in and out of a corresponding orifice 186 formed in the secondary stem housing 172. The secondary stem housing 172 may include a push button 188, such that when push button 188 is engaged, the finger members 182 may be automatically extended from a retracted or stored position, as shown in FIGS. 3A and 3B, to an extended position as shown in FIG. 1. Conversely, when the push button 188 is disengaged, the finger members 182 may automatically be retracted from the extended position to the stored position, The components of the push button and linkages coupled thereto used to extend and retract the finger members are various and known in the art and are thus not described herein for simplicity.

In other implementations, the retractable hooks 180 may automatically adjust from their stored position to their extended position when the bottom end 174 of the secondary stem 170 is inserted into the second end 144 of the primary stem 140. Conversely, the retractable hooks 180 may automatically retract from their extended position back to their stored position when the bottom end 174 of the secondary stem 170 is disengaged from the second end 144 of the primary stem 140.

Similar to ball tips 152, ball tips 184 preferably comprise a rounded finish to prevent hair pieces that may be hung on the hooks 180 from being snagged as they are being removed from the hooks 180. The ball tips 152 may also be constructed from stainless steel, plastic, PVC, ceramic, or other suitable material.

FIG. 3A is a perspective view illustrating the hair station 100 in a stored configuration. As shown, in the stored configuration, the primary stem 140 is slidable within the hollowed interior of the base stem 130. The secondary stem 170 is slidable within the hollowed interior of the primary stem 140, such that the primary stem 140 may collapse within the hollowed interior of the base stem 130. The secondary stem 170 may collapse within the hollowed interior of the primary stem 140 in a telescoping fashion. Fastener collar 136 is rotatable about the base stem 130 to allow for the adjustment of the height of the primary stem 140 relative to the base stem 130. In some implementations, the fastener collar 136 may be ridged to provide an easier grip for the user. As such, the fastener collar 136 may be rotated clockwise or counterclockwise to fasten or unfasten the primary stem 140 within the base stem 130, respectively.

Similarly, fastener collar 146 is rotatable about the primary stem 140 to allow for the adjustment of the height of the secondary stem 170 relative to the primary stem 170. In some implementations, the fastener collar 146 may be ridged to provide an easier grip for the user. As such, the fastener collar 146 may be rotated clockwise or counterclockwise to fasten or unfasten the secondary stem 170 within the primary stem 140, respectively.

As also shown, the upper collar 106 of the base 102 is slidable along the outer annual surface of the base stem housing 131, while the lower collar 104 is fixed to the closed end 132 of the base stem housing 131, thus causing the support members 110 and 118 to collapse in close proximity to the base stem 130 when the upper collar 106 is translated from a first position to a second position. In this way, the base lower collar 104 functions as a joint allowing the support members 110 and 118 (i.e., the tripod) to open up when setting up the station 100 for use and fold up the station 100 for storage. The upper collar 106 may be locked in place at a desired location along the base stem 130, for example, by a fastener or any other suitable means.

FIG. 3A is an exploded view illustrating the hair station 100 in the stored configuration. As shown, the base stem housing 131 may include a hollowed interior 302 for receiving the first end 140 of the primary stem 140. As such, the primary stem 140 is slidable within the hollowed interior 203 of the base stem. In the stored configuration, hooks 148 are retracted within orifices 154 of the primary stem 140 and hooks 180 are retracted within orifices 186 of the secondary stem 170.

The present disclosure provides a portable workstation that enables a hair stylist to hang natural or artificial hair and other haircare accessories thereupon while the hairstylist is styling, weaving, or braiding added hair into a client's hair. The present disclosure allows the user to drape added hair on the apparatus in various ways. On the top level (i.e., the secondary stem), there are hanger hooks that the user may utilize to hang and access unopened packs of hair or drape open packs of hair. Additionally, the hanger hooks are disposed along the primary stem at various heights to enable the user to manage, separate, and access the added hair as the user needs to use it. The smooth rounded finish of the hanger hooks prevents the added hair from tangling while being hung.

The hair station of the present disclosure minimizes the tangling of the added hair while styling because the hair rests on hooks, thus reducing unintended movement, falling, or slipping of added hair from a chair, countertop, or other support surface. The present disclosure allows the user to access the added hair faster, thus reducing the time required to style a client's hair.

The station 100 is also easily assembled, adjustable in height, mobile, compact, lightweight and sturdy. The station 100 also minimizes the space needed to manage and store the added hair. The station 100 may further include one or more electrical sockets for providing power to hair care accessories such as a hair dryer or curling iron. While the present disclosure describes the station for use in hair styling applications, the disclosure may apply to other applications.

The specially contoured ring-like hooks allow stylists to access a continuous feed of any length and all grades of hair (curly, straight, kinky). The station provides multiple hanger hooks at varying levels. These hooks are adjustable and can be pulled out of the shaft to accommodate more hair or less hair. The station allows the stylist to set up and continue styling the client's hair uninterrupted until the styling is complete. Further, in some implementations, the user may choose to color the hooks different colors to identify different strands or textures of added hair.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A portable hair station, comprising:
a base supporting a base stem housing;
a primary stem housing telescopically coupled to the base stem housing, where the primary stem housing comprises a first plurality of hooks that automatically extend from the primary stem housing as the primary stem housing engages the base stem housing and retract into the primary stem housing as the primary stem housing is disengaged from the base stem housing; and
a secondary stem housing telescopically coupled to the primary stem housing, where the secondary stem housing comprises a second plurality of hooks that automatically extend from the secondary stem housing as the secondary stem housing engages the primary stem housing and retract into the secondary stem housing as the secondary stem housing is disengaged from the primary stem housing.

2. The portable hair station of claim 1, where the first plurality of hooks automatically extend from the primary stem housing when a first button coupled to the primary stem housing is engaged and automatically retract into the primary stem housing when the first button is disengaged.

3. The portable hair station of claim 1, the second plurality of hooks automatically extend from the secondary stem housing when a second button coupled to the secondary stem housing is engaged and automatically retract into the secondary stem housing when the second button is disengaged.

4. The portable hair station of claim 1, where the first plurality of hooks comprise a rounded end finish.

5. The portable hair station of claim 1, where the second plurality of hooks comprise a rounded end finish.

6. The portable hair station of claim 1, where the primary stem comprises one or more hanger hooks with a rounded end finish, where the hanger hooks automatically adjust in length when the secondary stem is inserted into the primary stem.

7. The portable hair station of claim 1, where the base stem housing is supported by a collapsible tripod base having support members coupled to the base stem housing.

8. The portable hair station of claim 1, where the base stem housing includes a first collar fastener rotatably coupled to the base stem housing, the first collar fastener being configured to enable the height of the primary stem housing to be adjusted relative base stem housing.

9. The portable hair station of claim 1, where the primary stem housing includes a second collar fastener rotatably coupled to the primary stem housing, the second collar fastener being configured to enable the height of the second stem housing to be adjusted relative primary stem housing.
